(19) United States
(12) Patent Application Publication
(10) Pub. No.: US 2009/0098357 A1
(43) Pub. Date: Apr. 16, 2009

(54) Structural Insulation Sheathing

(76) Inventors: Gregory S. Bergtold, Midland, MI (US); Mridula Kapur, Lake Jackson, TX (US); Michael H. Mazor, Midland, MI (US); Hoang T. Pham, Lake Jackson, TX (US); Mark G. Spencer, Lewisville, TX (US); Gary C. Welsh, Cincinnati, OH (US)

Correspondence Address: WHYTE HIRSCHBOECK DUDEK S.C./DOW;Intellectual Property Department, 555 East Wells Street, Suite 1900, Milwaukee, WI, 53202, US

(21) Appl. No.: 12/091,971

(22) PCT Filed: Oct. 26, 2006
(86) PCT No.: PCT/US2006/060258

§ 371 Date: Jul. 29, 2008

Related U.S. Application Data
(60) Provisional application No. 60/732,969, filed on Nov. 3, 2005.

(51) Int. Cl. B32B 5/32; B32B 27/32

(52) U.S. Cl. 428/218; 428/220; 428/423.1; 428/523

(57) ABSTRACT

Structural insulation sheathing (SIS), preferably in the form of a panel, comprises a structural facer and an insulation member. The structural facer and insulation members are in intimate, planar contact with one another, both are plastic, and the SIS structure meets both the structural (i.e., ASTM E72) and insulation (R>2) requirements for the North American residential market. The structural facer member of the SIS structure is high-density polyolefin foam. The structural facer comprises a skin/core structure with the skins of a higher density than the core, and the structural facer has a flexural modulus typically of at least about 30,000 pounds per square inch (psi). The insulation member of the SIS is a foamed sheet of thermoplastic, e.g., polyisocyanurate.

### CROSS REFERENCE TO RELATED APPLICATION

This application claims the benefit under 35 USC §119(e) of U.S. Provisional Application No. 60/732,969 filed Nov. 3, 2005.

### FIELD OF THE INVENTION

This invention relates to structural sheathing. In one aspect, the invention relates to structural insulation sheathing (SIS) while in another aspect, the invention relates to a structural insulation sheathing panel comprising at least one facial member and an insulation member. In yet another aspect, the invention relates to a building wall comprising a SIS panel.

### BACKGROUND OF THE INVENTION

The residential construction market has structural sheathing (SS) products that offer no insulation, e.g., oriented strand board (OSB) and plywood, and it also has insulated sheathing (IS) products that offer limited structural properties, e.g., expanded polystyrene (EPS), extruded polystyrene (XPS) and polyisocyanurate foam (PIR). These products are typically in panel form. As wood products become scarce and thus more costly to produce, OSB and plywood are expected to be increasingly costly and difficult to obtain. Thus a SS product made entirely of plastic material is desirable. Producing a sheathing product that combines both insulation and structural properties, e.g., a SIS panel, is also desirable.

ASTM E72 defines the structural performance of structural sheathing products for the North American residential market. The North American climate dictates the temperature range for both installation and service. Certain targets for these products include a nominal ½ inch thickness, an insulation rating of R>2 and the ability to use conventional fastening, e.g., staples, screws or nails. The conventional fasteners must not pull out under all normal weather conditions. While most sheathing panels (including SS, IS and SIS) can be glued to a building wall, the cost and time required for this mode of installation does not make it a practical alternative to the use of mechanical fasteners.

In order to effectively attach a conventional SS panel to a building wall, the maximum dimension separating the reinforcing members of its structural component must be less than the diameter of the nail, staple or screw used to secure the product to a stud or other framing element. For plywood or OSB, this is not a problem. However, for a panel comprising a metal mesh facer in combination with a sheet of foamed insulation, the size of the hole through which the nail is fitted must be smaller than the shaft of the nail to insure firm attachment of the panel to the wall. As a practical matter, this requirement eliminates or severely restricts the use of honeycomb and other mesh reinforcements as the structural component of a SIS product because the panel could move once nailed to the wall. Moreover, ideally the head of the screw or nail, or the crown of the staple, is separated from the stud of the building wall to which it is attached only by a wire or strand of the mesh and this, of course, is not possible due to the presence of the insulation component of the SIS product.

### SUMMARY OF THE INVENTION

In one embodiment of this invention, structural insulation sheathing, preferably in the form of a panel, comprises a structural facer (aka “facial”) member and an insulation member. The structural facer and insulation members are in intimate, planar contact with one another, both are plastic, and the SIS structure meets both the structural (i.e., ASTM E72) and insulation (i.e., R>2) requirements for the North American residential market.

The structural facer member, or simply structural facer, of the SIS structure is high density polyolefin foam. The foam comprises a skin/core structure with the skins of a higher density than the core. The core density may be reduced by any means of introducing voids, such as melt phase foaming using chemical or physical blowing agents, or introduction of voided fillers. The skin or skins are the reinforcing component of the structural facer of the SIS structure. The overall density of the structural facer is between about 0.30-1.39, preferably between about 0.301.20, more preferably between about 0.30-0.70 and still more preferably between about 0.35-0.56, grams per cubic centimeter (g/cm³). Typically, the total skin thickness of the structural facer comprises 10-50%, preferably 15%-35% and more preferably 18-25%, of the total thickness of the structural facer. Typically and preferably, the skin thickness is evenly divided between the two planar surfaces of the facial member. The overall thickness of the facial member is typically between about 0.0625-0.250 inches (about 1.584.8 millimeters (mm)), more preferably between about 0.125-0.1875 inches (about 3.175-4.8 mm).

In a preferred embodiment of this invention, the structural facer of the SIS product is a multi-layer sheet comprising high density polyolefin, the sheet comprising a first skin layer, a foam core or intermediate layer, and a second skin layer in a sandwich configuration. The densities of the skin layers are higher than the density of the intermediate foam layer.

In one embodiment of the invention, the flexural modulus (or simply modulus) of the structural facer is at least about 30,000 pounds per square inch (psi). In another embodiment of the invention, the flexural modulus is at least about 35,000 psi, preferably at least about 40,000 psi.

The overall thickness of the SIS product is preferably between about 7/16 and 9/16 inches (about 0.4375 to 0.5625 inches or about 11.11 to 14.28 mm). Preferably, the structural facer is as thin as practically possible to allow for an insulation member as thick as practically possible to achieve the best possible insulation value (R) while still meeting the structural requirements of ASTM E72. The insulation member is typically a foamed sheet of EPS, XPS, or PIR.

In another embodiment the structural facers of the SIS products of this invention are prepared using the high density foam technology (HDFT) described in U.S. Pat. No. 6,544,450. Use of HDFT allows for the construction of very thin structural facers while maintaining the structural requirements of ASTM E72. This, in turn, allows for reduced cost inasmuch as less material is required to provide structurally acceptable products. Other advantages of using HDFT for manufacturing SIS structural facers include (i) good moisture resistance (similar to a plastic foam sheathing), (ii) cutting and attachment of the SIS structure to framing members (e.g., studs) using conventional saws and fasteners e.g., nails, nail or staple guns, (iii) good resistance to thermal transmission, e.g., an R value (° F.*ft²*h/Btu) of about 0.17, and (iv) lower weight structural components with a density of about 0.40 g/cm³.

In yet another embodiment, the multi-layer structural facer of the SIS product comprises a blend of (i) high density polyethylene (HDPE) and/or polypropylene, and (ii) low density polyethylene (LDPE). In this embodiment, the multi-layer structural facer with a skin/foam/skin configuration has a of density of about 0.41 g/cm³, a modulus of about 50,000 psi, and a thickness of about 3/16 inches (4.8 mm). When combined with PIR foam of 0.064 g/cm³ density made with a pentane blowing agent at a thickness of 0.3125 inches (7.93 mm), the SIS panel meets the targeted overall thickness, ASTM E72 racking strength, and R insulation value.

In still another embodiment the invention is a building wall comprising a SIS product in which the SIS product, typically in panel form, comprises structural facer and insulation members that are in intimate, planar contact with one another. Both members are plastic, and the SIS structure meets both the structural (i.e., ASTM E72) and insulation (i.e., R>2) requirements for the North American residential market.

### BRIEF DESCRIPTION OF THE DRAWINGS

FIG. 1 is a schematic of a SIS composite or structure of this invention attached to a stud of a building wall.

FIG. 2A is a schematic of an A-B structural facer.

FIG. 2B is a schematic of an A-B-A structural facer.

FIG. 3 graphically reports the insulation value R versus the racking strength of the inventive facer and several conventional facers.

FIG. 4 reports the effect of talc and foam on the modulus of HDPE (MI=4.52 g/10 min) structural facers.

FIG. 5 reports the effect of talc and foam on the modulus of HDPE (MI=7.95 μl 0 min) structural facers.

FIG. 6 reports 16-inch racking performance versus structural facer density of various HDPE structural facers.

FIG. 7 reports small scale racking test deflections of various HDPE structural facers and conventional facer products.

### DESCRIPTION OF THE PREFERRED EMBODIMENTS

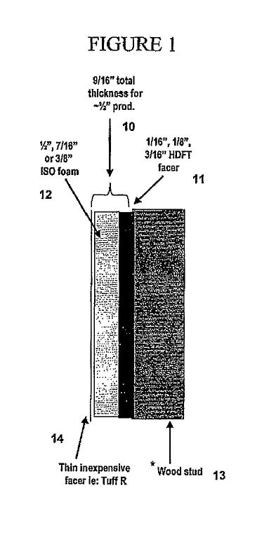

Referring to FIG. 1, one embodiment of the invention is composite panel 10 comprising structural facer 11 in intimate planar contact with foam insulation sheet 12. Structural facer 11 and foam insulation sheet 12 are joined to one another in any conventional manner, and composite panel 10 is fastened to stud 13 using conventional fasteners (not shown), e.g., nails, screws, staples, and the like. While the orientation of the composite to the stud as shown in FIG. 1, i.e., structural facer 11 in contact with stud 13, is the preferred orientation to maximize racking strength, in a less preferred embodiment the orientation is reversed, i.e., insulation sheet 12 is in contact with stud 13.

Optionally, the planar face of foam insulation sheet 12 opposite the planar face in intimate contact with structural facer 11 can be covered or in intimate contact with a nonstructural facer sheet 14. Optional nonstructural facer sheet 14 is typically very thin and made of inexpensive material, e.g., fiber, paper, plastic, a composite of two or more of these materials, or, optionally, a reflective material such as a metallized plastic film or aluminum foil.

“Planar surface” is used in distinction to “edge surface”. If rectangular in shape or configuration, a panel will comprise two opposing planar surfaces joined by four edge surfaces (two opposing pairs of edge surfaces, each pair intersecting the other pair at right angles). The panels can be of any size and shape and as such, so can the planar and edge surfaces, e.g., thin or thick, polygonal or circular, flat or wavy, etc.

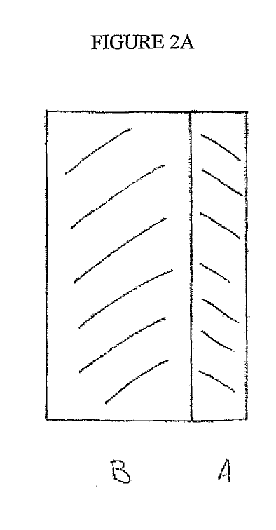

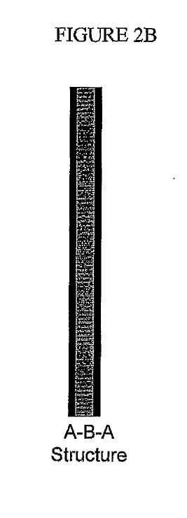

Structural facer 11 is further illustrated in FIGS. 2A and 213. In FIG. 2A the structural facer is shown in an A-B or B-A configuration, the A component a high density skin and the B component a low density layer or core. In FIG. 2B the structural facer is shown in an A-B-A configuration in which the A components are high density skin layers and the B component is a low density intermediate or core layer. FIG. 21 illustrates the preferred configuration of the structural facers of this invention.

As used in the context of a structural facer of this invention, “high density” simply means that the A component or skin or surface layer of the structural facer has a higher density than the B component intermediate or core layer of the structural facer. The core layer will contain a large amount of small air or other gas pockets or voids relative to the skin layer, and thus the core layer will have a lower structural or bulk density than the skin layer. The difference in structural densities between the A and B components of the structural facer will vary with a number of factors or variables, including whether the structural facer is filled or unfilled, the composition of the plastic, the thickness of the core relative to the skin(s), and the like. By way of example, if the structural facer comprises an unfilled HDPE or polypropylene (PP) with a total skin volume of about 20%, then the difference in densities between the skin and core layers is typically at least about 0.31, more typically at least about 0.51 and even more typically at least about 0.63, g/cm³. The overall density of the unfilled structural facer, i.e., the density of the structural facer including both the A and B components, is typically between about 0.30 and about 0.70, preferably between about 0.30 and about 0.60 and more preferably between about 0.35 and about 0.45, g/cm³.

The density of the A component(s) of the structural facer, i.e., the skin, correlates well with the density of the plastic from which it is formed. If a polypropylene, then the density is typically at least about 0.87, preferably at least about 0.88 and more preferably at least about 0.89, g/cm³. If an HDPE, then the density is typically at least about 0.93, preferably at least about 0.94 and more preferably at least about 0.95, g/cm³. If the skin layer is filled, then its density will be the arithmetic average of the densities of its filler and plastic components. The maximum density of the A component is limited only by practical considerations.

The density of the B component of the structural facer, i.e., the core, is a calculated density. It is determined algebraically from the density of the composite as a whole and the density of the skin layer(s), and it is calculated as follows:
Density (ρ) of total facer, core and skin
   ρₜₒₜₐₗ: measured
   ρₛₖᵢₙ: resin density
   ρ_{core}” calculated
Volume of total facer, core, and skin
   Vₜₒₜₐₗ: measured
   Vₛₖᵢₙ: measured
   V_{core}: calculated
Mass of total facer, core, and skin

Mₜₒₜₐₗ=ρₜₒₜₐₗ*Vₜₒₜₐₗ

Mₛₖᵢₙ=ρₛₖᵢₙ*Vₛₖᵢₙ

M_{core}=Mₜₒₜₐₗ−Mₛₖᵢₙ
Calculation of core density

ρ_{core}=M_{core}/V_{core}

ρ_{core}=(Mₜₒₜₐₗ−Mₛₖᵢₙ)/(Vₜₒₜₐₗ−Vₛₖᵢₙ)

ρ_{core}=((ρₜₒₜₐₗ*Vₜₒₜₐₗ)−(ρₛₖᵢₙ*Vₛₖᵢₙ))/(Vₜₒₜₐₗ−Vₛₖᵢₙ)

One typical procedure for measuring the density of the composite as a whole is to weigh a sample of the composite, then immerse it in water, and then divide the weight of the sample by the change in the volume of the water due to the immersion of the sample. Another procedure for measuring the density of the B component is ASTM D-3575-93, Suffix W, Method A (i.e., determine foam volume by linear measurement of a specimen (a ten centimeter cross-section cut from the foam), weigh the specimen, and then calculate its apparent density (weight per unit volume)).

Since the overall thickness of the SIS ideally is between about 7/16 and about 9/16 inch (for use in the North American building construction market), the structural facer is manufactured as thin as practical to allow for the use of a sheet of insulation of maximum thickness. The overall thickness of the structural facer is typically between about 0.0625 and about 0.250 inches, preferably between about 0.125 and about 0.1875 inches. Of this thickness, the total skin thickness, i.e., the thickness of the skin layer in an A-B configuration or the sum of both skin layers in an A-B-A configuration, is typically between about 10 and about 30, preferably between about 15 and 25 and more preferably between about 18 and about 22, percent of the total structural facer thickness. In an A-B-A configuration, typically and preferably each A component or skin layer is of about equal thickness.

The structural facer sheet comprises high density polyolefin foam. Any polyolefin or blend of polyolefins with a density in excess of about 0.87, preferably in excess of about 0.88 and more preferably in excess of about 0.89, g/cm³ can be used in the practice of this invention, Typically and preferably the foam comprises high density polyethylene (HDPE) and/or polypropylene, and either or both can be filled or unfilled. Other polyolefins, e.g., polyvinylchloride or chlorinated polyethylene, filled or unfilled, can also be used. In one embodiment, the facer comprises an unfilled blend of HDPE and low density polyethylene (LOPE). The amount of LDPE in the blend can range from zero to about 40, preferably from about 5 to about 30 weight percent. Such blends typically have a melt flow rate or melt index (MI, I₂ at 190 C) of between about 1 and about 10 g/10 min. The LDPE adds melt strength to the HDPE. In another embodiment, the structural facer comprises an unfilled blend of PP and a polyethylene elastomer, the latter promoting the modulus and/or stiffness of the facer. The amount of elastomer in the blend can vary widely, but it is typically similar to the amount of LDPE in a HDPE/LDPE blend.

The surface of the structural facer that abuts or is in contact with the construction stud or other frame or reinforcing member preferably has a rough matt or textured finish to promote attachment of one to the other. The opposite planar surface of structural facer is also preferably of a rough matt or textured surface to promote attachment to the insulation sheet. The structural facer may contain one or more additives, e.g., pigment, anti-oxidant, flame retardants, processing aids, slow release adhesives (these promote adhesion to the construction stud after nailing or other mechanical fastening of one to the other) and the like, and/or fillers, e.g., talc, glass fiber, fly ash, clay, wollastanite, calcium carbonate and others identified in published U.S. application 2005/0070673. Typically, the filler component of the structural facer does not exceed about 50, preferably does not exceed about 45 and more preferably does not exceed about 40, weight percent based on the total weight of the structural facer, The addition of an infrared (IR) blocker, e.g., carbon black, or the attachment of a reflective facer can increase the insulation value R of the SIS composite. The structural facers are preferably permeable to water vapor to allow the building to breathe.

In one embodiment of this invention, the structural facer comprises a filled blend of HDPE and LDPE. In another embodiment, the structural facer comprises a filled blend of PP and a polyethylene elastomer.

The insulation sheet or component of the SIS composite comprises any material that will provide the inventive article with the desired greater than about (>) 2 insulation rating (R). These materials include expanded and/or extruded polystyrene, polypropylene, rigid or semi-rigid polyurethane foams, and rigid polyisocyanurate foams. The insulation foams are made by conventional techniques and can include a filler or insert, such as fiberglass. The thickness of the insulation foams are such that when joined to the structural facer, the total thickness of the composite SIS is between about 7/16 and about 9/16 inch.

The SIS can be constructed by any one of a number of different methods. In one embodiment, a structural HDFT facer is co-extruded directly onto the foam insulation sheet. In this embodiment, the HDFT structural facer bonds directly and strongly to the foam insulation sheet without the need for an adhesive or other form of fastener. In another embodiment, on-line PIR liquid foaming is employed. The latter promotes good adhesion of the insulation foam to the structural facer as well as a desirable insulation value and in situ lamination. If the surface of the foam insulation sheet receiving the structural facer is rough or textured, then the bond between the two is likely improved than if the surface is smooth. The adhesion of the structural facer for the insulation layer is enhanced by corona treatment of the structural facer. Other surface treatments of either the structural facer or insulation layer can also promote adhesion between the two layers.

In forming the structural facer, the high-density foam technology described in U.S. Pat. No. 6,544,450 is useful. This technology allows for a reduction in density while maintaining the structural properties of the thin sheet. Other useful methods for making the structural facers of this invention include those taught in U.S. Pat. Nos. 3,523,988, 4,071,591, 4,154,785, 5,876,813, 5,882,776 and 6,716,379 and WO 96/00643 and 2002/074843. The SIS composite can be of any size and shape, and conventional sheathing sizes are preferred, e.g., 4′×8′, 9′ and 10′ length boards. Standard nailing (or staple or screw) patterns are used to attach the SIS composite to the construction studs.

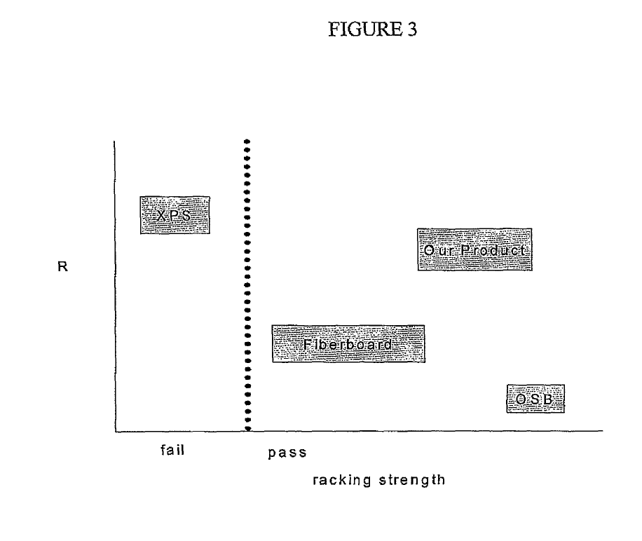

The plastic structural facer provides the required strength yet is thin enough to allow for sufficient insulating foam, and the resulting composite can be attached with conventional fasteners. The structural facer enables on-line PIR foaming on a continuous line lamination process. As noted above, the PIR foam and structural facer are self-bonding, and the addition of the PIR foam to the thin structural facers results in a composite structure that achieves a racking performance and insulation value superior to that of the individual components (structural facer and PIR foam) alone as shown in FIG. 3.

### Specific Embodiments

### Process for Producing Structural Facers:

The high-density foamed structural facer is manufactured in a co-extrusion process composed of an A-B-A structure of high-density skins with a lower density foamed core. The skins are co-extruded in a volume (or thickness) ratio of 10 to 30% with the core structure providing the remaining volume. Foam was produced using the process described in U.S. Pat. No. 6,544,450 and the extruder system of its Example 1, although the resin formulations of these examples differ from those of the examples of the '450 patent. Table I collects the formulations and base properties of the A-B-A structural facers used in the examples.

### Process for Producing Structural Facer/PIR Foam Laminates:

A fabrication box (36×35× 7/16 inches) was used as a container to produce restrained-rise foams laminated directly to structural facers produced by the extrusion process described above. The facer was placed exterior-side down in the box, a box pour of polyisocyanurate (PIR) foam precursor was made, a nonstructural facer, typically, a 0.8 to 3.4 mil facer and more preferably a 0.9 to 1.5 mil facer, is placed on top of the pour and the box closed providing a restrained rise reaction producing a 7/16 inch thick SIS composite.

The PIR formulation (total of 323.39 g) comprises Component A (total of 190.89 g), Component B (total of 128 g), and Component C (total of 4.50 g). Component A comprises PAPI 20 PMDI (poly(diphenylmethane diisocyanate), 181.80 g) available from The Dow Chemical Company (TDCC) and an 80/20 blend of cyclo-pentane and iso-pentane (9.09 g). Component B comprises Terate 3512 (100 g) available from Invista Corp., an 80/20 blend of cyclo-pentane and iso-pentane (13.20 g), Vorasurf 504 surfactant (2.50 g) available from TDCC, RB 7940 catalyst (11.80 g) available from Albemarle, and water (0.50 g). Component C comprises Pelcat 9887B surfactant (4.50 g) available from Pelron.

The PIR prototype process comprised the following conditions and steps:

1) All components at room temperature.
2) Mix A &B for 10 seconds.
3) Add C and mix for 3 seconds.
4) Pour into heated mold (set at 140 F for 1 hour to condition)
5) Close mold.
6) Maintain mold at 140 F for 1 hour.
7) Remove from mold
Procedure for Testing Nail Pull Resistance. ASTM D7161

### Procedure for Determining Nailability:

Nail through the facer surface into a 2×4 wood stud at both room temperature and 20 F. If fracture or breakage lines are observed in the facer surface, the material fails the test. If the material fails the nailability test then it is an unsuitable material for the small-scale racking test.

Procedure for testing Tensile Strength (Yield) and Tensile Modulus (Tangent): ASTM D 638
Procedure for testing Thermal Resistance: ASTM C 518-02e1

The “Small Scale Racking Test” procedure is described in Racking Strength of Paperboard Based Sheathing Materials, Wu Bi, Master of Science, Miami University, Paper Science and Engineering, 2004. The described nailing pattern was followed.

### Polymer Descriptions:

TABLE 1
Facer Polymer Properties

| | Melt Index | Density | Crystallization |
|---|---|---|---|
| Polymer Name* | (I2)** | (g/cm³) | Rate at 120 C. |
| DX5E66 - PP | 8.7 | 0.9073 | 0.61 |
| homopolymer | | | |
| D118 - PP homopolymer | 8 | 0.91 | NA |
| LDPE 662i homopolymer | 0.5 | 0.919 | NA |
| DMDA 8904 - HDPE | 4.517 | 0.951 | 0.83 |
| DMDA 8007 - HDPE | 7.95 | 0.967 | 0.46 |
| Affinity PL1880G - PO | 1.0 | 0.902 | NA |
| plastomer | | | |
| DMDH 6400 - HDPE | 0.7 | 0.961 | 0.2 |

*All polymers available from The Dow Chemical Company.
**MI was measured at 230 C. and 190 C. respectively for the PP and PE polymers according to ASTM 1238.

TABLE 2
Nailability Results correlated to Polymer Properties

| Sample | | | |
|---|---|---|---|
| Ref | Polymer Name | Nailability | Comments |
| 2.1 | DX 5E66 (core and skin) | Fail | Brittle fracture around |
| | | | nail site |
| 2.2 | Core - D118 w/ | Fail | |
| | 7% LDPE 662i - Skin | | |
| | D118 w/20% PL1880 | | |
| 2.3 | Core - HDPE 8904 + | Pass | No cracking or fracture |
| | 15% | | |
| | 662i Skin - HDPE8904 | | around nail site |
| 2.4 | Core - HDPE 8007 + | pass | No cracking or fracture |
| | 15% | | |
| | 662i Skin - HDPE8007 | | around nail site |
| 2.5 | Core DMDH 6400 + | pass | No cracking or fracture |
| | 15% 662i Skin - 8904 | | around nail site |

Attempts to make structural facers from other blends of polymers for use in the nailability test were unsuccessful. The resulting facers demonstrated cracking or fracture around the nail site during nail testing.

TABLE 3
Description of Facer Samples with Test Results

| | | | | | Thermal | | |
|---|---|---|---|---|---|---|---|
| | High | | | | Conductivity | Facer | |
| | Density | Polymer | | Density* | (R value) | Thickness | Modulus |
| Ex. No | Foam Facer | Composition | Filler | (g/cm³) | (° F. * ft² * h/Btu) | (inch)** | (psi) |
| 1 | HDPE 1 | HDPE 8904 | None | 0.40 | 0.177 | 0.120 | 34000 |
| 2 | HDPE 2 | HDPE 8904 | 15% talc | 0.44 | 0.168 | 0.122 | 40000 |
| 3 | HDPE 3 | HDPE 8007 | None | 0.44 | ND | 0.120 | 44000 |
| 4 | HDPE 4 | HDPE 8007 | 15% talc | 0.45 | ND | 0.125 | 54000 |
| | | | skin | | | | |
| 5 | HDPE 5 | HDPE 8007 | 15% talc | 0.42 | ND | 0.123 | 57000 |
| | | | skin and | | | | |
| | | | core | | | | |
| 6 | HDPE 6 | HDPE 8007 | 15% talc | 0.41 | ND | 0.182 | 50000 |
| | | | skin and | | | | |
| | | | core | | | | |
| 7 | A′ | HDPE 8904 + | None | 0.55 | ND | 0.123 | 48000 |
| | | 15% LDPE | | | | | |
| | | 662i | | | | | |
| 8 | B′ | HDPE 8904 + | None | 0.41 | ND | 0.130 | 33000 |
| | | 15% LDPE | | | | | |
| | | 662i | | | | | |

*Overall density of the A-B-A structure as measured by weighing the sample, then immersing the sample in water to measure its displacement, and then dividing the weight of the sample by the volume change in the water (i.e., the displacement).
**Measured with a micrometer.

TABLE 4
Composite Samples Identified by Facer Material*

| | | Thickness | Thermal | Racking |
|---|---|---|---|---|
| | Facer | Composite | Conductivity | Stiffness** |
| Ex. No. | Material | (in) | (R/in) | (lb/in) |
| 9 | HDPE 1 | 0.557 | 3.26 | 2,200 |
| 10 | HDPE 2 | 0.530 | 2.80 | 2,400 |
| 11 | HDPE 3 | 0.520 | 2.78 | 2,300 |
| 12 | HDPE 4 | 0.521 | 2.79 | 2,800 |
| 13 | HDPE 5 | 0.632 | 3.16 | 2,400 |
| 14 | HDPE 6 | 0.592 | 2.84 | 3,200 |
| 15 | A′ | 0.563 | ND | 2,400 |
| 16 | B′ | 0.563 | ND | 1,800 |

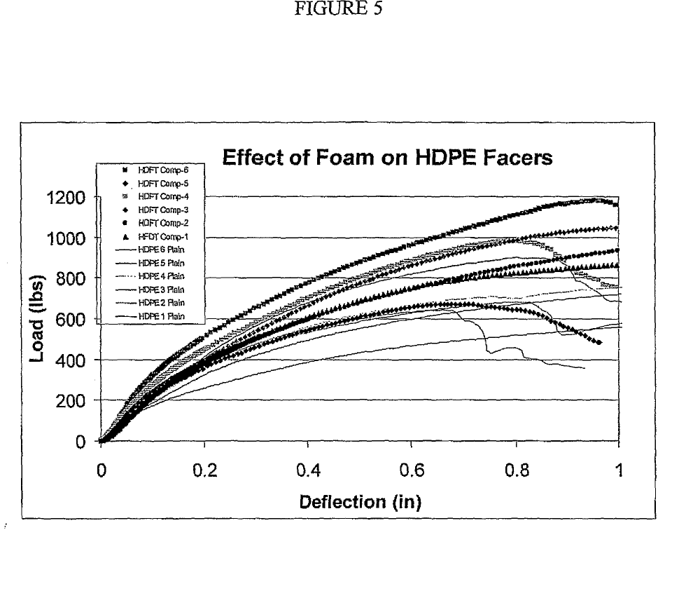

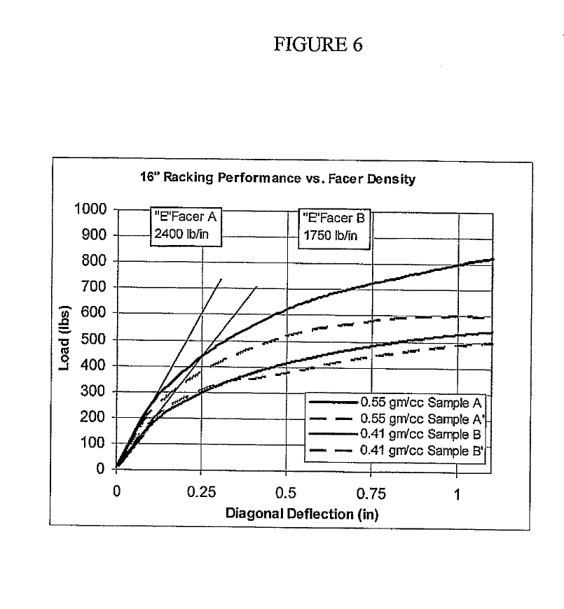

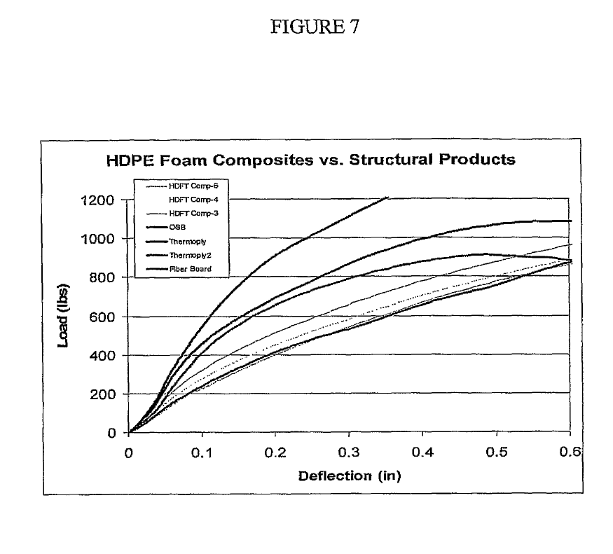

*The insulating foam for all the following composites was the same as per description above.
**Racking Stiffness was determined from the graph of either FIG. 5 or 6 using the methodology of FIG. 7 by calculating the slope of the load deflection curve at deflections below 0.1 inches.

As shown in Examples 6 and 14, a blend of HDPE and LDPE gives multi-layer sheet foam of 0.41 g/cm³ density, modulus 50,000 psi, and thickness of 0.182 mm. When combined with PIR foam of 0.064 gm/cm³ density made with pentane as a foaming agent at a thickness of 0.0.313 inches, yields a panel of the desired overall thickness, ASTM E72 racking strength and R value.

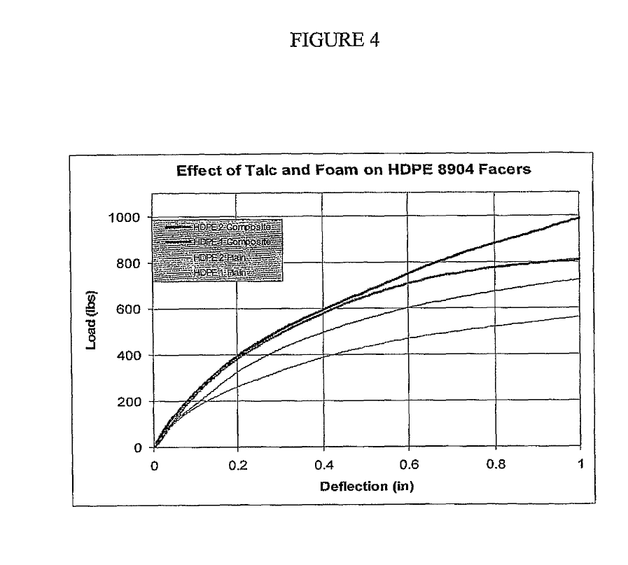

FIG. 4 shows that the addition of talc raises the modulus of the plain HDPE 8904 structural facer. The facer with talc filler has a higher racking stiffness as measured by the Small-Scale Racking Test (nailing pattern: 3-inch on the border, 6 inch in the field, measured from center of nail head to center of nail head) (compare Examples 1 and 3 of Table 3). The addition of talc to the structural facer improves the performance of a composite comprising the facer (compare Examples 9 and 10 of Table 4). The low deflection racking stiffness of both structural facers is improved by the addition of insulating foam to form a 7/16 inch composite. At higher deflection, the composite panel made from the structural facer with talc has a higher racking stiffness. Similar effects were observed when talc was added to the HDPE 8007 structural facers. See FIG. 5. The HDPE 4 composite (Example 12), even though its structural facer has a slightly lower modulus than the HDPE 5 structural facer, has a better racking strength than the HDPE 5 composite (Example 13), presumably because of the slightly increased structural facer thickness.

TABLE 5
Racking Performance vs. Facer Density

| | | | | Racking |
|---|---|---|---|---|
| | | Thickness | Modulus | Stiffness |
| Sample | Density (gm/cm³) | (inch) | (psi) | (lb/inch) |
| A | 0.55 | 0.123 | 48,000 | 2,400 |
| B | 0.41 | 0.13 | 33,000 | 1,800 |
| Ratio | 1.3 | 0.95 | 1.5 | 1.4 |

FIG. 6 and Table 5 show that increasing the structural facer density by 30% increases the structural facer modulus and the racking stiffness by 50% and 40%, respectively.

FIG. 7 shows that at Small-Scale Racking Test deflections of less than ½ inch, the composite foam samples are comparable to products that have demonstrated ability to meet or exceed ASTM E72 requirements (e.g., OSB, Thermoply™ (a thick cardboard construction with a thin sheet of polyethylene on each face) and fiberboard).

If the structural facer is without insulation value, then the insulating member must have an R-value of at least 5.75 R/inch for the full panel to have the desired R-value of >2. In the previous examples, polyisocyanurate foam (PIR) is used due to its higher W/inch value than conventional thermoplastic insulating foams, for example foamed polystyrene. The following expression describes the parameters dictating the R/inch requirements of the insulating layer:

$${R}_{Foam} = \frac{{R}_{Panel} \times {t}_{Panel} - {R}_{Facer} \times {t}_{Facer}}{{t}_{Foam}}$$

The parameter t refers to the thickness of a component of the panel and R refers to the thermal resistance as previously defined. The subscripts refer to the structural facer (“Facer”), the insulating member (“Foam”) or the complete panel comprising both components (“Panel”).

In a preferred process for making the inventive SIS panel, a continuous lamination PIR process is believed to be advantaged over using a separate step to laminate the insulating foam layer on the structural facer as the overall number of process steps and consequent handling are reduced.

If additional insulation were required to meet increased energy codes requirements for wall insulation, then a product using the same structural facer with additional foam thickness could be produced. The technology is identical to that described for the ½ inch product.

### Prophetic Full Scale Production Examples:

A) 0.5 g/cm³ density A: 8904 HDPE HDFT and B: 8904 HDPE HDFT (A-B-A structure at 10:80:10 percentage of thickness) at 0.185 inches foamed to nominal ½ inch and ASTM E72 tested.

B) 0.5 g/cm³ density A: 8904 HDPE w/talc at 15% and B: 8904 HDPE HDFT (A-B-A structure at 10:80:10 percentage of thickness) at 0.185 inches foamed to nominal ½ inch and ASTM E72 tested,

C) 0.5 g/cm³ density A: 8904 HDPE w/Calcium Carbonate at 20% and B 8904 HDPE HDFT (A-B-A structure at 10:80:10 percentage of thickness) at 0.185 inches foamed to nominal 12 inch and ASTM E72 tested.

D) 0.5 g/cm³ density A: 8007 HDPE HDFT and B: 8007 HDPE HDFT (A-B-A structure at 10:80:10 percentage of thickness) at 0.185 inches foamed to nominal 1 inch and ASTM E72 tested.

In one embodiment, the structural insulated sheathing is manufactured in a continuous line lamination process using either a restrained rise process as taught in U.S. Pat. No. 4,572,865 with structural facer fed in roll or sheet form with polyisocyanurate formulation applied directly to the structural facer.

In another embodiment a free-rise process as taught in U.S. Pat. No. 5,789,458 is used in which the structural facer is fed in roil form with polyisocyanurate applied between the roll fed structural and nonstructural facers. In both applications the rigid foam is applied at a density of 2-6 pounds per cubic foot and may be manufactured with or without glass fiber reinforcement. The nonstructural facer may be composed of a tri-laminate facer (a 3-ply facer system comprising kraft paper, polyethylene and aluminum foil), foil, or kraft paper that may or may not be impregnated with asphalt. The structural facer may be treated with a chemical or corona process to improve bonding of the structural facer to the foamed rigid insulation. The high-density foamed structural facer is manufactured in a co-extrusion process composed of an A-B-A structure of high-density skins with a lower density foamed core. The skins are co-extruded in a volume ratio of 10 to 30% with the core structure providing the remaining volume. The A-B-A structure can be manufactured using a lamination process to join the high-density skins with a foamed core structure. The panels will pass ASTM E72.

In another embodiment, this one for rigid foams other than PIR foams, SIS panels are manufactured in a glue line lamination process. Here, a vacuum press with platen is employed to bond the structural facers to the insulation layer.

Although the invention has been described in considerable detail, this detail is for the purpose of illustration. Many variations and modifications can be made on the invention as described above without departing from the spirit and scope of the invention as described in the appended claims. All U.S. patents and allowed U.S. patent applications cited above are incorporated herein by reference.

1. Structural insulation sheathing (SIS) comprising a structural facer and an insulation member in intimate, planar contact with one another, the SIS comprising (i) a structural facer comprising high-density polyolefin foam having a flexural modulus of at least about 30,000 pounds per square inch (psi), and (ii) a foamed insulation member, the SIS characterized as passing the structural racking strength of ASTM E72 and having an insulation value, R, equal to or greater than about 2.

2. The SIS of claim 1 in which the combined thickness of the structural facer and insulation member in intimate planar contact with one another is between about 7/16 and about 9/16 inch.

3. The SIS of claim 1 in which the foamed insulation member comprises at least one of polystyrene, polyethylene, polypropylene, polyurethane and polyisocyanurate.

4. The SIS of claim 1 in which the foamed insulation member comprises polyisocyanurate.

5. The SIS of claim 4 in which the face of the foamed insulation member opposite the face of the foamed insulation member in contact with the structural member is in intimate, planar contact with a nonstructural facer.

6. The SIS of claim 5 in which the nonstructural facer comprises at least one of fiber, paper, plastic and aluminum foil.

7. The SIS of claim 1 in which the structural facer comprises at least one of high-density polyethylene (HDPE), polypropylene, polyvinylchloride (PVC), chlorinated polyethylene, filled HDPE, filled polypropylene, filled PVC and filled chlorinated polyethylene.

8. The SIS of claim 1 in which the structural facer comprises a blend of HDPE and low-density polyethylene.

9. The SIS of claim 1 in which the structural facer comprises at least one high-density skin layer and a low-density core layer.

10. The SIS of claim 1 in which the structural facer comprises a low-density core layer sandwiched between two high-density skin layers.

11. The SIS of claim 1 in which the difference in densities between the skin layers and the core layer of the structural facer is at least about 0.40 g/cm³.

12. The SIS of claim 11 in which the density of the skin layer of the structural facer is at least about 0.89 g/cm³.

13. The SIS of claim 1 in which the thickness of the structural facer is between about 0.0625 and 0.250 inches.

14. The SIS of claim 1 made by co-extruding a structural facer directly onto a sheet of foamed insulation.

15. The SIS of claim 1 made by an on-line polyisocyanurate liquid foaming process.

16. The SIS of claim 1 attached to a building wall.

17. The SIS of claim 16 in which the SIS is attached to the building wall by a non-adhesive fastener.

18. A structural facer for combination with a sheet of foamed insulation to form a structural insulation sheathing characterized as passing the structural racking strength of ASTM E72 and having an insulation value, R, equal to or greater than about 2, the structural facer having a thickness between about 0.0625 and about 0.250 and comprising (i) high-density polyolefin foam, and (ii) at least one high-density skin layer and a low-density core layer.

19. The structural facer of claim 18 comprising at least one of high-density polyethylene (HDPE), polypropylene, polyvinylchloride (PVC), chlorinated polyethylene, filled HDPE, filled polypropylene, filled PVC and filled chlorinated polyethylene.

20. The structural member of claim 18 comprising a low-density core layer sandwiched between two high-density skin layers with a difference in densities between the skin layers and the core layer of at least about 0.31 g/cm³.
